(19) United States
(12) Patent Application Publication
(10) Pub. No.: US 2008/0044346 A1
(43) Pub. Date: Feb. 21, 2008

(54) Use of a powder composition and a medium

(75) Inventors: Lars Hultman, Viken (SE); Rose-Marie Yttergren, Helsingborg (SE); Per Engdahl, Arlid (SE)

Correspondence Address: BUCHANAN, INGERSOLL & ROONEY PC, POST OFFICE BOX 1404, ALEXANDRIA, VA, 22313-1404, US

(73) Assignee: HOGANAS AB, Hoganas (SE)

(21) Appl. No.: 11/889,616

(22) Filed: Aug. 15, 2007

Related U.S. Application Data
(60) Provisional application No. 60/838,898, filed on Aug. 21, 2006.

(30) Foreign Application Priority Data
Aug. 16, 2006 (SE) 0601697-6

(51) Int. Cl. C01G 49/08

(52) U.S. Cl. 423/632

(57) ABSTRACT

The invention relates to the use of a powder composition comprising at least 95% by weight of magnetite (Fe₃O₄) particles as a magnetisable component in a medium for magnetically storing information. At least 99.9% by weight of the magnetite particles have a particle size of less than 5 μm, and the magnetite particles have a polyhedral shape and essentially isotropic magnetic properties. The magnetite particles have a saturation magnetisation of 75-95 emu/g at 10 kOe, a remanence of 20-40 emu/g and a coercivity of 250-500 Oe. The invention also relates to the medium for magnetically storing information comprising magnetite particles.

### CROSS REFERENCE TO RELATED APPLICATIONS

The benefit is claimed under 35 U.S.C. § 119(a)-(d) of Swedish Application No. 0601697-6, filed Aug. 16, 2006, and under 35 U.S.C. § 119(e) of U.S. Provisional Application No. 60/838,898, filed Aug. 21, 2006.

### FIELD OF THE INVENTION

The present invention relates to the use of a magnetic powder composition for magnetically storing information. Said uses include MICR (Magnetic Ink Character Recognition) and other applications of a similar kind.

### BACKGROUND OF THE INVENTION

MICR is a way of magnetically storing information in printed matter by the use of magnetisable ink or toner which is magnetised during printing. This print may later be read by detecting the magnetic properties of the print and translating it into characters (letters, numbers, etc) corresponding to the stored information. Related techniques may also comprise magnetising the magnetisable ink or toner after printing, or applying the magnetisable ink or toner as a layer.

Magnetite (Fe₃O₄) is also called black ore in the general literature, and is previously known for use as a black pigment, in e.g. paint, ink and concrete.

The US patent application with the publication number 2005/0287351 discloses a packaging laminate where at least one of the material layers included in the laminate include magnetisable particles, whereby parts of the laminate can be magnetised to constitute guide markings. According to one example use is made of substantially spherical magnetisable particles having a diameter of approximately 0.5 μm. According to US 2005/0287351 trials have been conducted with a plastic film containing approximately 0.1 weight percent of magnetite.

The magnetic powder of 2005/0287351 has however been shown to be difficult to disperse in a carrier medium without highly vigorous mixing. It is also known that the magnetic properties of the magnetisable units are crucial in order to obtain a medium which may be magnetised and then is able to retain its magnetisation for a sufficient time period. 2005/0287351 is silent regarding the magnetic properties of the used magnetisable particles.

The U.S. Pat. No. 5,914,209 discloses the use of a mixture of hard and soft magnetites which allows for sufficient high remanance for MICR (Magnetic Image Character Recognition) applications.

In this way U.S. Pat. No. 5,914,209 aims at providing a convenient average magnetisation hardness, but it may be noted that the mixture also retains the undesired properties of both the hard and the soft magnetites i.e. the hard magnetite particles being difficult to magnetise as desired, and the soft particles having a low remanence, thereby losing the stored information.

The U.S. Pat. No. 5,552,252 also disclose the use of a mixture of hard and soft magnetites.

Further, magnetite has been used for both its pigment and its magnetic characteristics in printing media.

U.S. Pat. No. 6,726,759 discloses an aqueous ink-jet composition for MICR applications comprising a metal oxide with a particle size of less than 0.5 μm and remanence of at least 25 emu/g. The patent does not discuss all relevant aspects on how to obtain an ink-jet composition optimised for MICR applications.

U.S. Pat. No. 5,780,190 discloses an ionographic process in which a magnetic toner is used. The magnetic toner may be used for MICR applications, specifically for sorting cheques in MICR reader/sorters. U.S. Pat. No. 5,780,190 is concerned with avoiding or minimising problems with image smearing and offsetting of the toner to read and write heads. The toner is comprised of a core of a polymer and magnetite and is encapsulated by a polymeric shell. The magnetite has a coercivity of 80 to 250 Oe, preferably 80 to 160 Oe, and a low remanence of 20 to 70 Gauss, preferably from 25 to 55 Gauss. Again, the patent does not discuss all relevant aspects on how to optimise the toner for MICR applications.

EP patent application EP1512669 A1 describes magnetite particles containing 0.1-1% by mass of phosphorous, having a coercive force of 10 to 25 kA/m in an applied magnetic field of 796 kA/m and having an octahedral shape. In contrast to the current invention the magnetic particles described in the EP application contains phosphorus originating from water soluble phosphorous compounds.

In MICR and other related applications the magnetisable particles used need magnetic properties suitable for these applications, e.g. sufficiently high remanence and saturation magnetisation is needed in order to ensure that the magnetic pattern may easily be read, preferably from a distance, also a long time after the printing and magnetisation, as well as sufficiently low coercivity in order to facilitate the de- and re-magnetisation of the magnetisable particles. None of the prior art discloses magnetic powder particles possessing saturation magnetisation, remanence and coercivity properties which all are favourable for magnetic character recognition applications.

Thus there is a need for a magnetic powder having appropriate semi-hard magnetic properties, and which is easily dispersible in a carrier medium.

### SUMMARY OF THE INVENTION

An objective of the present invention is to provide a solution on how to provide a magnetic powder which has magnetic properties suitable for use for magnetic storing of information.

An other objective of the present invention is to provide a solution on how to provide a magnetic powder which has magnetic properties suitable for use for magnetic reading of information.

An other objective of the invention is to provide a solution on how to provide a magnetic powder which is easily dispersed in a carrier medium.

These objectives are according to the present invention achieved through the use of a powder composition comprising at least 95% by weight of magnetite (Fe₃O₄) particles, wherein at least 99.9% by weight of the magnetite particles have a particle size of less than 5 μm, and wherein the magnetite particles have a polyhedral shape and essentially isotropic magnetic properties, the magnetite particles having a saturation magnetisation of 75-95 emu/g at 10 kOe, a remanence of 20-40 emu/g and a coercivity of 250-500 Oe as a magnetisable component in a medium for magnetically storing information.

The polyhedral shape together with the small particle size makes the magnetite particles of the powder composition easy to disperse in a carrier liquid, such as a liquid polymer solution or an aqueous ink solution or any other appropriate carrier.

The semi hard magnetite with a polyhedral shape and a saturation magnetisation of 75-95 emu/g at 10 kOe, a remanence of 20-40 emu/g and a coercivity of 250-500 Oe eliminates the need for mixing hard and soft magnetic particles in order to obtain magnetic properties desired for MICR applications or other application where information is magnetically stored with the aid of magnetic particles, such as when magnetite particles are included in a magnetisable film or layer. In order to work satisfactory in such applications (MICR etc) the magnetic particles need to be easy to magnetise even from a distance, but should however not be so sensitive that there is a risk of the magnetically stored information being lost due to unintentional demagnetisation. These apparently contradictory requirements have been suitably balanced using the magnetite in accordance with the invention, thus achieving magnetic particles which are both easy to magnetise, even from a distance, and magnetically stable enough not to be unintentionally demagnetised.

The powder composition of the inventive use may comprise at least 95% by weight of magnetite particles, preferably at least 98% by weight of magnetite particles.

The magnetite may be natural or synthetic. Preferably the magnetite is natural magnetite which is ground into very small particles, of which at least 99.9% by weight of the magnetite particles have a particle size of less than 5 μm. Natural magnetite is preferred as it is currently not possible to obtain synthetic magnetite particles having the same shape and magnetic properties as the magnetite particles of the present invention.

The magnetite particles of the powder composition should have a particle size distribution such that at least 99.9% of the particles have size of less than 5 μm, preferably less than 3 μm, and more preferably less than 2 μm, in order to exhibit the above discussed magnetical and dispersion properties. By size is meant the diameter of the particles.

Further, a weight average particle size of the magnetite particles of less than 2 μm, preferably less than 1 μm, is advantageous in obtaining the above discussed magnetical and dispersion properties in the magnetite particles.

The magnetite particles may have a saturation magnetisation of 75 to 95 emu/g at 10 kOe, preferably 80-90 emu/g at 10 kOe.

Further, the magnetite particles may have a remanence of 20 to 40 emu/g, preferably 25-35 emu/g.

Also, the magnetite particles may have a coercivity of 250 to 500 Oe, preferably 300 to 450 Oe.

### DETAILED DESCRIPTION OF THE INVENTION

Currently preferred magnetite particles of the powder composition have a particle size such that at least 99.9% of the particles have a diameter of less than 1.56 μm, and the magnetite particles have an average particle size of about 0.45 μm, but other particle size distributions may also used with good results.

### EXAMPLE

The dependency of magnetic properties of milled natural magnetite particles on average particle size was investigated.

Natural magnetite was milled to 8 different average particle sizes from 0.35 μm to 33.6 μm, after which the saturation magnetisation, remanence and coercivity of all respective different average particle sizes where determined for an external magnetic field of 10 kOe and 1 kOe respectively. The results are given in Table 1 below.

TABLE 1

| | | Average particle size (μm) | | | | | | | |
|---|---|---|---|---|---|---|---|---|---|
| | | 0.35 | 0.45 | 1.3 | 2.1 | 2.6 | 7.0 | 11.0 | 33.6 |
| 10 kOe | Sat. mag. (emu/g) | 83 | 84 | 91 | 87 | 89 | 92 | 90 | 93 |
| | Remanence (emu/g) | 32 | 32 | 18 | 21 | 24 | 16 | 10 | 4 |
| | Coercivity (Oe) | 390 | 384 | 250 | 190 | ~200 | 120 | 60 | 30 |
| 1 kOe | Sat. mag. (emu/g) | — | 46 | — | — | 53 | 60 | — | — |
| | Remanence (emu/g) | — | 19 | — | — | 18 | 14 | — | — |
| | Coercivity (Oe) | — | 266 | — | — | 180 | 115 | — | — |

It is clear from the results that in order to obtain the sought combination of saturation magnetisation (75-95 emu/g), remanence (20-40 emu/g) and coercivity (250-500 Oe) at a field strength of 10 kOe, a low average particle size is needed.

Concerning the variables used, “saturation magnetisation” is the limit of magnetisation that a given material can reach i.e. a further increase of an external magnetic field will give no further magnetisation of the material, “remanence” is the magnetization left behind in the material after the external magnetic field is removed (as regards the present description, unless otherwise specified, the external magnetic field is a field of 10 kOe, which is believed sufficient to obtain saturation magnetisation), and “coercivity” is the intensity of the applied magnetic field required to reduce the magnetization of that material to zero after the magnetization of the sample has been driven to saturation (as regards the present description, unless otherwise specified, a magnetic field of 10 kOe was used to obtain saturation magnetisation).

Concerning the units used, Oe stands for Oersted which is the CGS-unit for magnetic field strength and emu/g stands for the dipole moment (“electro magnetic unit”) per mass.

The “diameter” or “particle size” of a magnetite particle is defined as the smallest possible diameter of a sphere which is large enough to essentially encompass the particle.

The “average” particle size is defined as the weigh average particle diameter.

In accordance with a preferred embodiment the powder composition for use in a medium for magnetically storing information comprises at least 98% by weight of magnetite particles, wherein at least 99.9% by weight of the magnetite particles have a particle size of less than 3 μm, and wherein the magnetite particles have a polyhedral shape and essentially isotropic magnetic properties, the magnetite particles having a saturation magnetisation of 80-90 emu/g at 10 kOe, a remanence of 25-35 emu/g and a coercivity of 300-450 Oe.

As mentioned above, satisfactory results may in many cases be achieved also with powders of a slightly different composition, in respect of one or more characteristics, as indicated above and in the claims.

1. A process for the production of a medium for magnetically storing information, comprising: providing as a magnetizable component in said medium, a powder composition comprising at least 95% by weight of magnetite (Fe₃O₄) particles, wherein at least 99.9% by weight of the magnetite particles have a particle size of less than 5 μm, and wherein the magnetite particles have a polyhedral shape and essentially isotropic magnetic properties, the magnetite particles having a saturation magnetization of 75-95 emu/g at 10 kOe, a remanence of 20-40 emu/g and a coercivity of 250-500 Oe.

2. The process according to claim 1, wherein the mean weight average particle size of the magnetite particles is less than 2 μm.

3. The process according to claim 1, wherein the powder composition comprises at least 98% by weight of magnetite particles.

4. The process according to claim 1, wherein at least 99.9% by weight of the magnetite particles have a particle size of less than 3 μm.

5. The process according to claim 1, wherein the magnetite particles have a saturation magnetization of 80-90 emu/g at 10 kOe.

6. The process according to claim 1, wherein the magnetite particles have a remanence of 25-35 emu/g.

7. The process according to claim 1, wherein the magnetite particles have a coercivity of 300-450 Oe.

8. A medium for magnetically storing information comprising magnetite particles, wherein at least 99.9% by weight of the magnetite particles have a particle size of less than 5 μm, and wherein the magnetite particles have a polyhedral shape and essentially isotropic magnetic properties, the magnetite particles having a saturation magnetization of 75-95 emu/g at 10 kOe, a remanence of 20-40 emu/g and a coercivity of 250-500 Oe.

9. The process according to claim 2, wherein the powder composition comprises at least 98% by weight of magnetite particles.

10. The process according to claim 2, wherein at least 99.9% by weight of the magnetite particles have a particle size of less than 3 μm.

11. The process according to claim 3, wherein at least 99.9% by weight of the magnetite particles have a particle size of less than 3 μm.

12. The process according to claim 1, wherein at least 99.9% by weight of the magnetite particles have a particle size of less than 2 μm.

13. The process according to claim 2, wherein the magnetite particles have a saturation magnetization of 80-90 emu/g at 10 kOe.

14. The process according to claim 3, wherein the magnetite particles have a saturation magnetization of 80-90 emu/g at 10 kOe.

15. The process according to claim 4, wherein the magnetite particles have a saturation magnetization of 80-90 emu/g at 10 kOe.

16. The process according to claim 2, wherein the magnetite particles have a remanence of 25-35 emu/g.

17. The process according to claim 3, wherein the magnetite particles have a remanence of 25-35 emu/g.

18. The process according to claim 4, wherein the magnetite particles have a remanence of 25-35 emu/g.

19. The process according to claim 2, wherein the magnetite particles have a coercivity of 300-450 Oe.

20. The process according to claim 3, wherein the magnetite particles have a coercivity of 300-450 Oe.
